(19) United States
(12) Patent Application Publication
(10) Pub. No.: US 2026/0267031 A1
(43) Pub. Date: Sep. 10, 2026

(54) BALLISTIC WEATHER METER

(71) Applicant: Sheltered Wings, Inc. d/b/a Vortex Optics, Barneveld, WI (US)

(72) Inventors: Todd Clermont, Barneveld, WI (US); Ben Farrell, Barneveld, WI (US); Dustin Langsdorf, Barneveld, WI (US); Jacob Powell, Barneveld, WI (US)

(21) Appl. No.: 19/350,937

(22) Filed: Oct. 6, 2025

Related U.S. Application Data
(60) Provisional application No. 63/703,355, filed on Oct. 4, 2024.

(51) Int. Cl. G01W 1/02

(52) U.S. Cl. CPC G01W 1/02

(57) ABSTRACT

In one embodiment, the disclosure relates to a device for providing a ballistic solution and for measuring one or more environmental conditions. In one embodiment, the disclosure relates to a device for calculating a ballistic solution based on data from at least one module for measuring at least one environmental condition, wherein the module is coupled to the device. In one embodiment, the module is removable from the device.

### CROSS-REFERENCE TO RELATED APPLICATIONS

This application claims priority to and is a non-provisional patent application of U.S. Provisional Patent Application No. 63/703,355 filed Oct. 4, 2024, which is incorporated herein by reference in its entirety.

### FIELD

In one embodiment, the disclosure relates to a device for measuring, calculating, and providing environmental data, ballistic solutions, weapon profiles, range cards, and other network information. In one embodiment, the device communicates measured environmental data, ballistic solutions, weapon profiles, range cards, and other network information through wireless communications including but not limited to Bluetooth, near field communication (NFC), LoRa©, and LoRaWAN©.

### BACKGROUND

In competition shooting or western hunting, ballistic calculations/corrections are based on a number of factors, including the range of the target, environmental conditions, rifle profile, and bullet profile, and are critical in making accurate long-range shots. The many variables that must be accounted for when shooting long range can be problematic for a shooter to track. Weather and wind data are not always readily accessible, for example. This may be because a mobile phone or computer is not available or able to communicate with the internet, or because the data isn't relevant in their precise location, or because a mobile device is impractical, or because these are difficult variables to estimate. For example, although temperature may be easily estimated by a shooter, wind speed is difficult to accurately estimate, and atmospheric pressure is extremely difficult to estimate without a tool.

Thus, a need exists for having a device that can provide difficult to obtain variables for the shooter in an accurate, timely and efficient manner, such that they can be used for ballistic calculations.

### SUMMARY

In one embodiment, the disclosure relates to a device for providing a ballistic solution.

In one embodiment the device includes a ballistic weather meter that includes at least one ballistics calculator and at least one module coupled to the device for measuring environmental conditions. In one embodiment, the module is configured to be removable from the device. In one embodiment, the module couples to a top portion of the device.

In one embodiment, the device includes two or more ballistic calculators. In one embodiment, the device is configured to allow the user to select one ballistic calculator to be functional from among two or more ballistic calculators. In one embodiment, the device includes two or more ballistic calculators, wherein all but one of the ballistic calculators are in an inactive state.

In one embodiment, the ballistic weather meter calculates a ballistic solution based on a plurality of sensors deployed in an array, wherein the sensors are in wireless communication with the ballistic weather meter.

In one embodiment, the ballistic weather meter includes one or more ballistic calculators and one or more modules for measuring environmental conditions, wherein the one or more modules are not integrated into the device, and wherein the ballistic calculator calculates ballistic characteristics based on environmental conditions measured by the one or more modules.

In one embodiment, the disclosure relates to a device comprising: a front portion, a back portion, a top side, and a bottom side, the front portion having a multi-button interface and a display, a processor with at least one ballistic calculator, a system for wireless communications, a mounting feature on the top side for a removable first module, and a removable first module configured to mount to the top side of the device.

In one embodiment, the disclosure relates to a device comprising: a body having a front portion, a back portion, a top side, and a bottom side, the front portion having a multi-button interface and a display, the body having an inner portion with a processor with at least one ballistic calculator, a system for wireless communications, the top side having a mounting feature for a removable first module, and a removable first module configured to mount to the top side of the device.

In one embodiment, the multi-button interface is a five button interface.

In one embodiment, the at least one ballistic calculator is one ballistic calculator.

In one embodiment, the rear portion is configured to secure a range card.

In one embodiment, the at least one ballistic calculator is two ballistic calculators. In one embodiment, the at least one ballistic calculator is three ballistic calculators. In one embodiment, the at least one ballistic calculator is four ballistic calculators. In one embodiment, the at least one ballistic calculator is from one to ten ballistic calculators.

In one embodiment, the mounting feature comprises a rail interface, a connector, and a latch button.

In one embodiment, the system for wireless communications is Bluetooth communication.

In one embodiment, removable first module is selected from the group consisting of: an environmental and weather related module, a wind measurement module, a Global Positioning System (GPS) beacon, a flashlight, a solar panel configured to provide power to the device, a battery pack configured to provide power to the device, a shot timer, and a mosquito repellent system.

In another embodiment, the removable first module is an environmental and weather related module. In another the removable first module is a battery pack configured to provide power to the device. In another embodiment, the removable first module is a solar panel configured to provide power to the device.

In one embodiment, the removable first module has a mounting feature for a removable second module.

In yet another embodiment, the device further comprises a removable second module, wherein the removable second module is configured to mount to the first module and has a mounting feature for a removable third module.

In another embodiment, the removable first module is a battery pack configured to provide power to the device and the removable second module is an environmental and weather related module.

In yet another embodiment, the device is configured to communicate with a rangefinder or a riflescope, or a binocular, or a spotting scope, or a thermal devices, or a night vision device, or a ballistic fob, or a heads-up display, or a mobile phone.

### BRIEF DESCRIPTION OF THE DRAWINGS

FIG. 1 is a front perspective view of one embodiment of a ballistic weather meter in accordance with the non-limiting principles of this disclosure;

FIG. 2 is a rear perspective view of the ballistic weather meter of FIG. 1;

FIG. 3 is a schematic view of one embodiment of a ballistic weather meter in accordance with the non-limiting principles of this disclosure having a removable DOPE card;

FIG. 4 is a perspective view of the ballistic weather meter of FIG. 1, with one embodiment of an external module attached to the ballistic weather meter in accordance with the non-limiting principles of this disclosure;

FIG. 5 is a detailed perspective view of the ballistic weather meter of FIG. 4, showing the external module removed from the ballistic weather meter;

FIG. 6 is a detailed view of one embodiment of a wind impeller that may be used with the ballistic weather meter of FIG. 1, showing a support and bearing;

FIG. 7 is a partial section view of the wind impeller of FIG. 6, showing one embodiment of an adjustment bearing for setting shaft clearance in accordance with the non-limiting principles of this disclosure;

FIG. 8 is a schematic view of one embodiment of a wind field generated by a sensor array in accordance with the non-limiting principles of this disclosure;

FIG. 9 is a schematic view of one embodiment of a wind meter array in accordance with the non-limiting principles of this disclosure;

FIG. 10 is a schematic view of one embodiment of a battery module in accordance with the non-limiting principles of this disclosure;

FIG. 11 is a schematic view of one embodiment of a rotatable wind impeller housing in accordance with the non-limiting principles of this disclosure;

FIG. 12 is a schematic view of one embodiment of a motion sensing module in accordance with the non-limiting principles of this disclosure;

FIG. 13 is a schematic view of one embodiment of a chronograph module in accordance with the non-limiting principles of this disclosure; and

FIG. 14 is a schematic view of one embodiment of a digital DOPE card in accordance with the non-limiting principles of this disclosure.

### DEFINITIONS

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

In this description, references to “one embodiment,” “an embodiment,” or “embodiments,” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

It will be understood that when an element or layer is referred to as being “on,” “connected to,” or “coupled to” another element or layer, it can be directly on, connected or coupled to the other element or layer. Alternatively, intervening elements or layers may be present. In contrast, when an element is referred to as being “directly on,” “directly connected to,” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section, without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

All patents, patent applications, and non-patent literature references are incorporated herein in their entireties.

The numerical ranges in this disclosure are approximate, and thus may include values outside of the range, unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually, as well as in any combination. Use of the singular includes use of the plural and vice versa.

As used herein, a “firearm” is a portable gun, being a barreled weapon that launches one or more projectiles often driven by the action of an explosive force. As used herein, the term “firearm” includes a handgun, a long gun, a rifle, shotgun, a carbine, automatic weapons, semi-automatic weapons, a machine gun, a sub-machine gun, an automatic rifle, and an assault rifle.

As used herein, a “target” is a person, an animal, or a place selected as the aim of a projectile. Non-limiting examples of suitable animal targets include game animals such as deer, ducks, turkey, and pheasant.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

As used herein, the term “shooter” applies to either the operator making the shot or an individual observing the shot in collaboration with the operator making the shot.

### DETAILED DESCRIPTION

In one embodiment, the disclosure relates to a handheld device that hunters and precision shooters can utilize to measure wind and weather data (humidity, pressure, temperature, density altitude), setup rifle and bullet profiles; calculate and display ballistic corrections in the field, a “ballistic weather meter.” The ballistic weather meter may be used with or without any other devices such as a rangefinder and/or mobile phone without departing from the principles of this disclosure.

A shooter must account for many variables when shooting targets at long range. Weather and wind data are not always readily accessible. This may be because a mobile phone or computer may not be available or able to communicate with the internet, or because the data isn't relevant in their precise location, or because a mobile device is impractical, or because variables are difficult to estimate. For example, although temperature may be easily estimated by a shooter, wind speed is difficult to accurately estimate, and pressure is extremely difficult to estimate without a tool. Having a device that can provide numerous variables for the shooter, without relying on internet communication, allows the shooter to engage targets they otherwise would not be able to hit. The ballistic weather meter solves those problems for the shooter.

The ballistic weather meter can be utilized by individuals, such as hunters and precision and competitive shooters, to measure wind and weather data (humidity, pressure, temperature, density altitude); setup rifle and bullet profiles; calculate and display ballistic corrections; determine direction; determine altitude; determine slope; determine longitude and latitude location; create and display private and government land maps; allow users to mark specific location on the map; provide navigation between two defined points; create and display wind and weather maps; generate, display, and transfer dope/range cards; transfer dope/range cards wirelessly to a removable digital dope card; support interchangeable modules that provide to functionality measure wind and weather data, provide emergency communication and electronic emergency response, provide secondary power sources; communicate wirelessly to multiple modules; communicate wirelessly to other network devices (range finders, rifle scopes, binoculars, spotting scopes, thermal devices, night vision devices, ballistic fobs, heads-up displays, and devices connected to the network). The combination of real-time range, wind and atmospheric data ensure the best possible ballistic elevation and wind correction data, as well as positioning data for tracking and/or finding game/targets.

In one embodiment, a ballistic weather meter may also contain one or more integrated ballistic calculators that utilize internal wind and atmospheric data, compass data for direction, sensors for incline, manually entered range, and ballistic profile information to calculate ballistic elevation and windage corrections. The ballistic weather meter may also use information from remote devices connected via a wireless network or other suitable means to calculate the current ballistic elevation and windage corrections. In one embodiment, these corrections can be viewed on the ballistic weather meter, or transmitted wirelessly to a separate display that can be mounted to a weapon or carried by the shooter. In one embodiment, the ballistic weather meter includes an integrated touch screen display and/or physical buttons to allows users to set up the device, display information, set up and manage both the device network and the module network.

Ballistics is currently a difficult field for a new shooter to become proficient. In one embodiment, the ballistic weather meter may lessen the new shooter's learning curve by using pre-loaded ballistic profiles of many common weapons, having set-up wizards to walk the user through fine tuning data or collecting difficult to measure data, and provide recommendations for set-up and shot specific items to aid the user in getting reliable ballistic data.

This ballistic weather meter can also be used in competition shooting applications. It allows a single user to leverage their toolbox of smart devices and optimize the source of data for distance, wind, weather, and ballistic calculation to achieve the best possible ballistic solution for their specific application. It is durable enough to be used in field conditions without risk of becoming non-operational by being shock resistant and waterproof.

In one embodiment, a team of competition shooters or a group of hunters can use the ballistic weather meter to communicate seamlessly between each other. For example, a hunter and a spotter can each utilize their own ballistic weather meters to simultaneously see distance, wind, weather, and ballistic solutions. In one embodiment, they may also be able to define the source of wind, weather, distance, and ballistic calculation between their devices. This flexibility allows them to optimize the data inputs necessary for accurate and optimal ballistic correction.

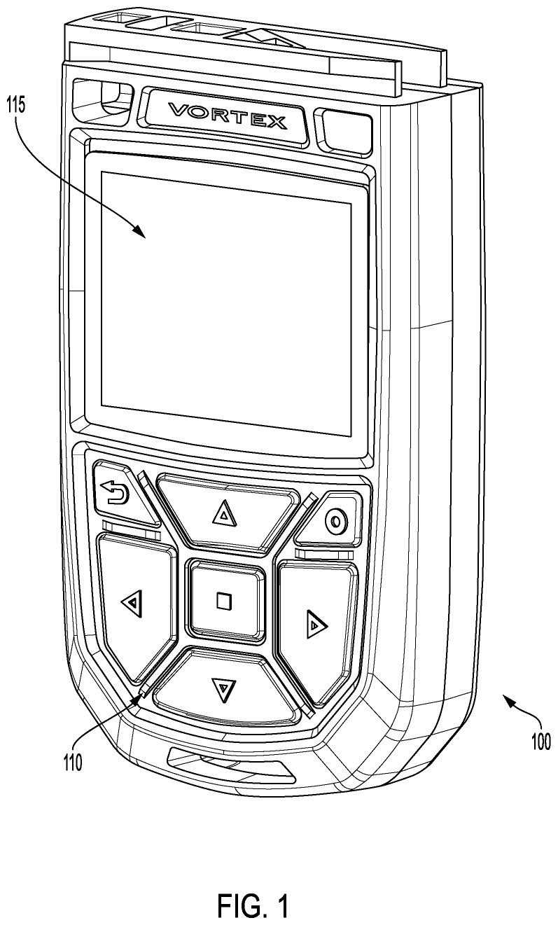

As shown in FIG. 1, the ballistic weather meter (100) includes a multi-button interface (110) paired with a high-resolution color display (115), making it easy to navigate the device. There is a significant amount of user inputs required for the ballistic solver to produce a solution. In some embodiments, the high-resolution color display may be a touchscreen. While total manual input is allowed, all users are provided with default weapon profiles that will eliminate the manual entry process for many users. In addition, bullet libraries also eliminate the need for manual entry. The user interface of this device was designed to emphasize information specific to ballistics. In some embodiments, the user interface and/or firmware of the ballistic weather meter may be updated wirelessly using “over-the-air” updates.

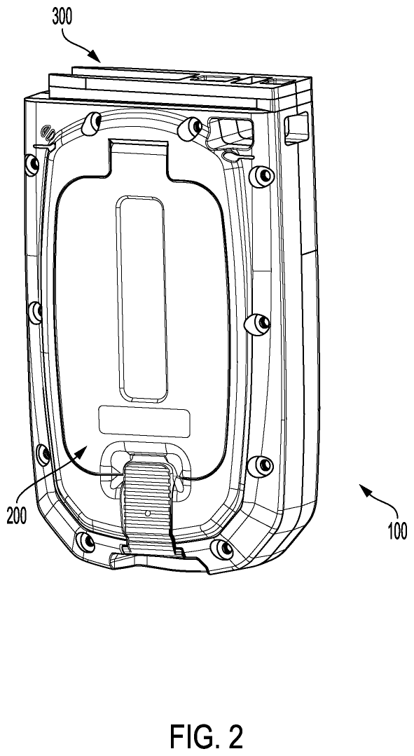

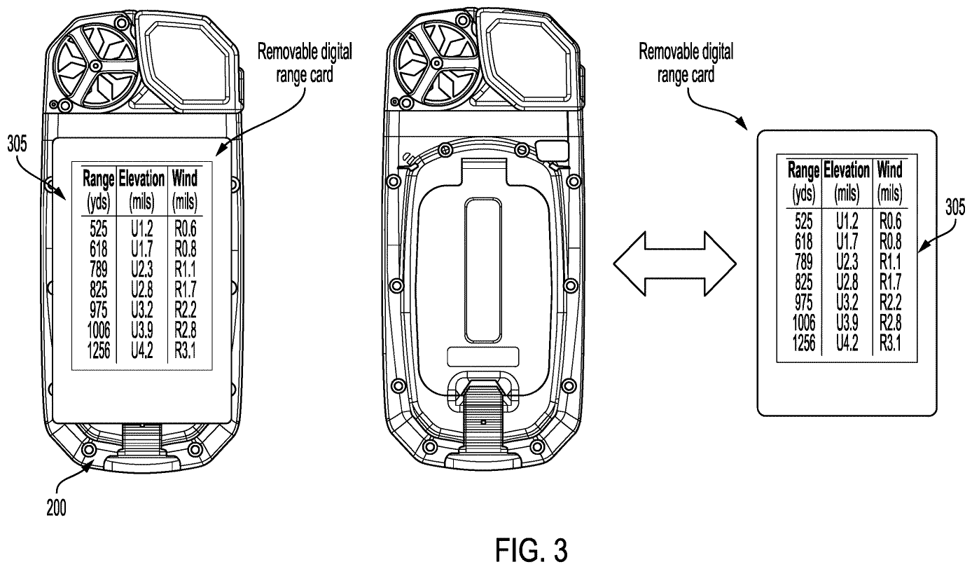

FIG. 2 is a rear perspective view of the ballistic weather meter of FIG. 1. As shown in FIG. 3, the digital range card or DOPE card (305) can be easily removed and reattached to the back portion (200) of the device (100). A range card or digital range card (305) can be coupled to the back (200) of the ballistic weather meter (100). This allows information to be readily displayed to the user without obscuring the display on the front side of the device.

In one embodiment, the ballistic weather meter allows users to choose modules that are useful for their application and attach them to the handheld ballistic weather meter. This attachment includes an electrical connection that allows serial communication, power distribution and attachment identification to the handheld ballistic weather meter. Some examples of interchangeable sensors and accessories are wind measurement module, environmental and weather related module, GPS beacon, flashlight, solar panel, additional battery pack, shot timer, mosquito repellent system, Bluetooth, NFC, LoRa, LoRaWAN etc. Some attachments may have functions not related to a ballistic solution or acquisition of environmental data.

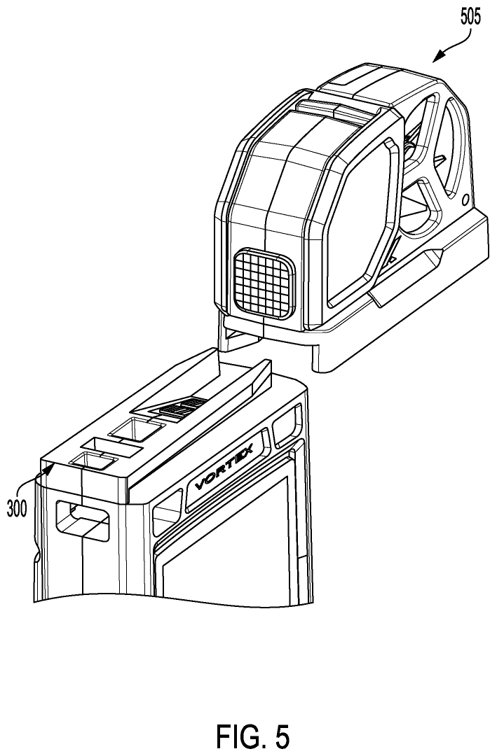

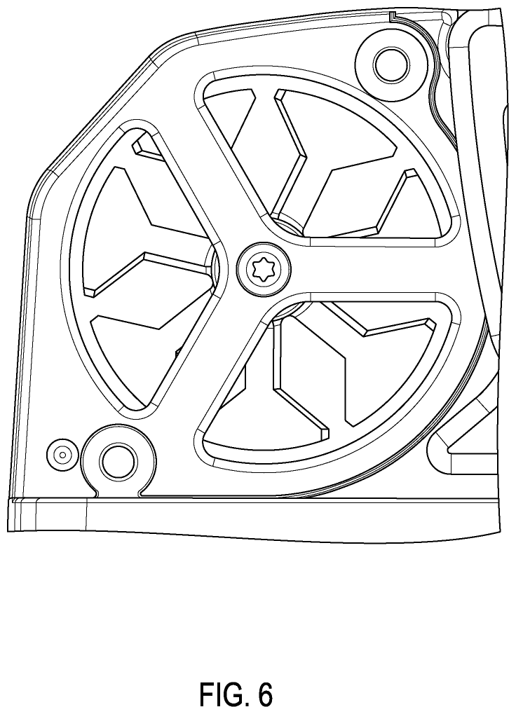

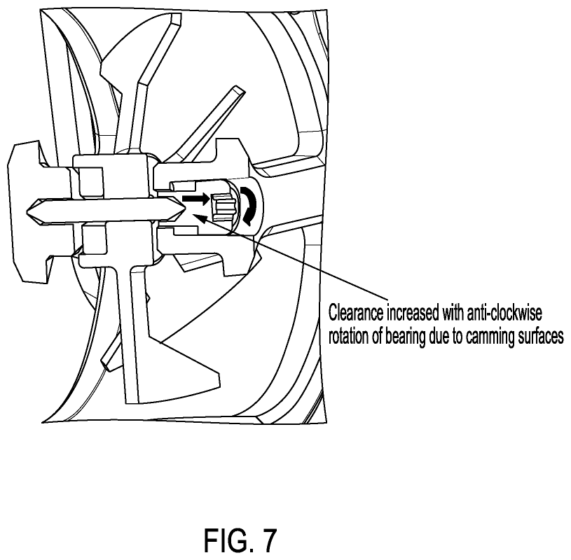

In one embodiment, and as shown in FIGS. 1-7, a ballistic weather meter (100) includes mounting features (300) for an external module (400), such as a wind measurement module to be mounted to the ballistic weather meter, thereby expanding the functionality of the meter. In one embodiment, as shown in FIG. 5, the external module (505) is removable and is configured to slide onto the top surface of the device.

In one embodiment, the mounting feature (300) may include at least one rail interface, connector, and latch button. Alternative embodiments may include additional or fewer mounting features without departing from the principles of this disclosure.

In one embodiment, external modules may allow the user to determine additional environmental conditions including, but not limited to, altitude, slope, and longitude and latitude. Further, external modules may also allow a user to create and display private and government land maps; provide navigation between two defined points; create and display wind and weather maps; generate, display, and transfer dope/range cards; transfer dope/range cards wirelessly to a removable digital dope card; support interchangeable modules that provide the functionality to measure wind and weather data, provide emergency communication and electronic emergency response, provide secondary power sources; communicate wirelessly to multiple modules; modules may communicate between other modules; communicate wirelessly to other network devices (range finders, rifle scopes, binoculars, spotting scopes, thermal devices, night vision devices, ballistic fobs, heads-up displays, and devices connected to the network).

In one embodiment, the ballistic weather meter can be paired with multiple network devices including, but not limited to, additional ballistic weather meters, a weapon mounted range finder, a viewing optic, a riflescope, and any device on a connected network. Pairing the ballistic weather meter with additional devices can be used to create a sensor array across a wide geographic area, thereby enabling a user to obtain detailed weather data within the array.

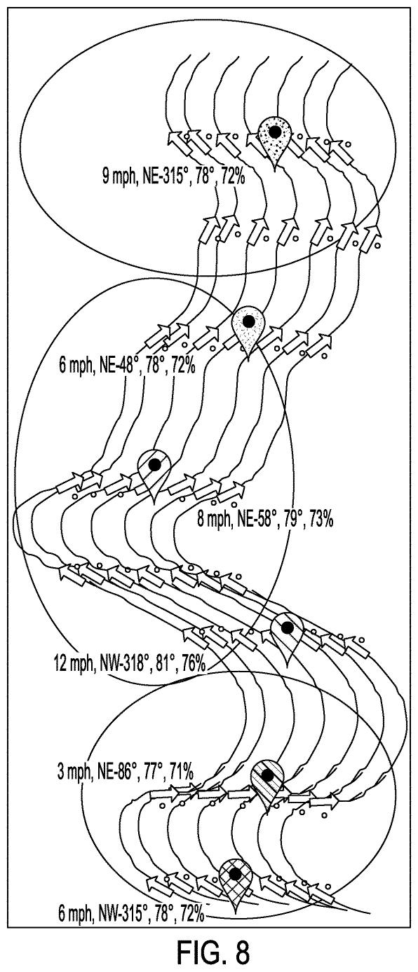

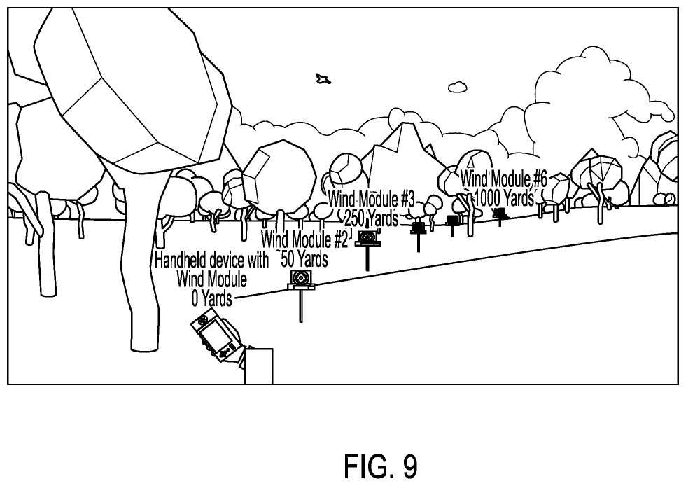

In one non-limiting example, multiple ballistic weather meters can be placed in different environmental conditions such that they are within range of wireless communication and can share the environmental data on a network. When multiple devices are sharing information on a network (as shown in FIGS. 8-9), the user can choose which device's information (essentially which environmental location) to use for the purpose of calculating a ballistic solution. In other words, each device can be a source of environmental data used while calculating a ballistic solution.

The ballistic weather meter can communicate wirelessly with other devices on the Vortex Relay Network or any other suitable network. Though different devices might be capable of capturing the same data, the data displayed is consistent across all network devices. This ensures that the entire network is using the same information for weapon profiles, range cards and other environmental data.

In one embodiment, the ballistic weather meter may automatically select the wind and weather sources without need for a user input. In one embodiment, the weather sources may be selected based on predetermined criteria that may or may not be user defined. In addition, if a selected weather source turns off for any reason, including but not limited to battery failure, loss of communication signal, or deliberately, the ballistic weather meter may automatically choose a new device that provides wind and/or weather data.

In one embodiment, the ballistic weather meter includes one or more onboard ballistic solvers. In one embodiment, the ballistic weather meter includes two or more ballistic solvers. When the device has multiple ballistic solvers, the user can select the ballistic solver that is functional to calculate the solution. At times, a user may prefer one solver over another solver.

If multiple ballistic weather meters are deployed in an array, the user may choose which ballistic weather meter—or other device including an onboard ballistic solver—is responsible for calculating the ballistic solution. In one embodiment, the ballistic source may be chosen without user input. If the device selected as the ballistic source turns off for any reason, including but not limited to battery failure, loss of communication signal, or deliberately, the ballistic weather meter may automatically choose a new device to act as the ballistic source and provide ballistic solutions.

The user can, in one embodiment, choose what device's measurements should be used in the ballistic calculation when using the ballistic weather meter with other network devices. The user might choose one source over another source because of the device's location. For example, if one device is located near the shooter and another device is located closer to the target, the user can choose to perform a ballistic calculation based on the remote location's environmental conditions (pressure, temperature, wind speed, wind direction). In another example, the user might choose one source over another source based on the measurement capabilities of a specific device. For example, if one device's hardware is capable of measuring more accurately than another, the user can choose to calculate the ballistic solution using the device that is most accurate.

In one embodiment, when using the ballistic weather meter with multiple network devices, the user can choose what device's ballistic solver should be used for the ballistic calculation. Vortex Relay devices use the same GeoBallistics solver. However, a third party ballistic solver may be used without departing from the principles of this disclosure. In one embodiment, a user could choose to supplement the ballistic weather meter with the external ballistic solver of their choice.

For example, a shooter may use the ballistic weather meter to capture environmental data and calculate a ballistic solution for one or multiple targets. Then the user would transfer that information to the removable dope card. Now the shooter can have access to their ballistic solutions without carrying the entire ballistic weather meter while they are shooting. The shooter can then update the removable dope card if they change weapons or if there is a change in environmental conditions.

In one embodiment, the ballistic weather meter includes default weapon profiles for commonly used weapons, a range card generator, access to bullet libraries, and an intuitive user interface. As described above, the ballistic weather meter includes a ballistic solver that is programmed into the ballistic weather meter and can produce ballistic solutions based on measured environmental data and user inputs specific to the weapon, projectile and target distance.

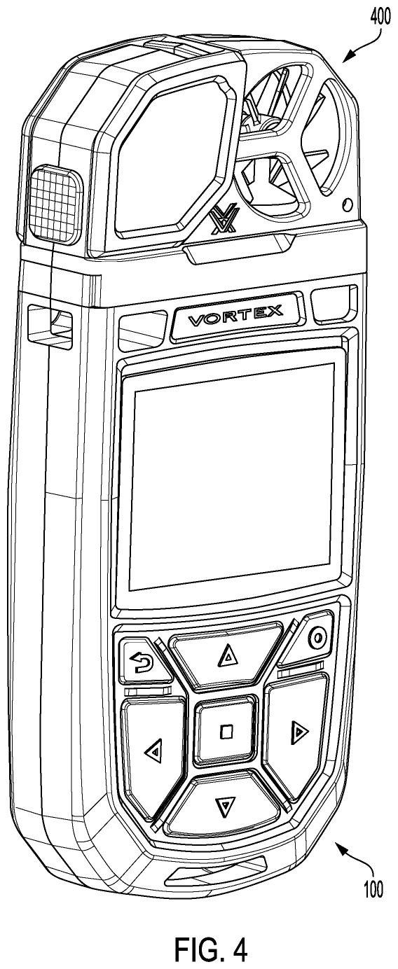

As shown in FIGS. 4-5, the user can attach different modules (400 and 505) based on their specific needs. In one embodiment, it is possible for the user to connect multiple sensors/accessories at a time by stacking them on top of the ballistic weather meter. The use of the interchangeable sensors/modules is not limited to supplementing the ballistic calculation. An attachment could be anything that provides information, requires power from, or delivers power to the ballistic weather meter. Existing ballistic weather meters may only include a mechanical wind vane as an attachment. In the embodiment shown, the interchangeable modules have a unique, universal, connector allowing multiple modules to be stacked on top of one another. In one embodiment, the module may not be related to ballistic calculations. In yet additional embodiments, the modules may supplement the battery life of the ballistic weather meter.

In one embodiment, the ballistic weather meter includes integrated electronics comprising at least a processor and a memory, wherein the integrated electronics provide at least one integrated ballistic calculator, and the necessary logic and code to drive the display, data entry devices, wireless communication, and data input controls. In one embodiment, at least one sensor is in communication with the integrated electronics. The at least one sensor may be integral to the ballistic weather meter or may be disposed remotely from the ballistic weather meter without departing from the principles of this disclosure.

In one embodiment, the sensor(s) that may communicate with the ballistic weather meter include a temperature sensor, magnetic field sensor (compass), hygrometer (humidity), barometer (atmospheric pressure), and an accelerometer. The ballistic weather meter may include additional sensors without departing from the principles of this disclosure. In other embodiments, the ballistic weather meter may include fewer sensors without departing from the principles of this disclosure.

The ballistic weather meter may also include wireless communication functionality including but not limited to Bluetooth, Near Field communication (NFC), wi-fi, or any other suitable wireless communication technology. Of course, the ballistic weather meter may also include wired communication means without departing from the principles of this disclosure.

In one embodiment, the ballistic weather meter may be part of a product ecosystem that uses a proprietary language. For example, the ballistic weather meter may be part of the Vortex Network, such that it may communicate with other devices on the Vortex network. Such devices may include, but are not limited to: ballistic solution (wind and elevation ballistic corrections), wind direction and speed, geographic coordinates, environmental conditions (humidity, temperature, pressure, and density altitude), multiple wind and atmospheric data groups, dope card/range card data, compass direction, slope information, weapon profile, and bullet profile.

In one embodiment, and as shown in FIG. 1, the ballistic weather meter includes a display (115) and a plurality of buttons (110) for controlling the ballistic weather meter. The ballistic weather meter has an interface that allows the user to interchange modules to change handheld unit functionality. In one embodiment, the interchangeable modules can be changed by the end user without the use of tools by depressing a button or lever to move a latch that allows the module to slide off. The main module mounting interface is to be positionally repeatable while also being robust against abuse. This is accomplished by matching rail interfaces that restrict movement in all directions and axis except the removal direction.

In one embodiment, the disclosure relates to a ballistic weather meter to which multiple external modules may be attached. Each external module may have a defined functionality and could contain the following capabilities: wireless communication and direct connection communication when attached to the handheld devices via a quick connector; battery, solar, kinetic energy, internal power sources, common connection interface to handheld and network devices.

In one embodiment, the external modules can operate in at least two modes. First, the module may be integrated to the ballistic weather meter when attached to the meter for fast communication and/or recharging. Alternatively, the module may operate remotely from the ballistic weather meter as an independent device that wirelessly communicates to the meter and other network devices. In one embodiment, the ballistic weather meter can communicate to multiple modules wirelessly.

In one embodiment and as shown in FIGS. 3-7, the external module may be a wind module that measures wind speed via a rotating impeller. The wind module may include a cover to protect the wind impeller from environmental damage that can be easily replaced by an end user. In one embodiment, the wind module may wirelessly communicate to the ballistic weather meter. In one embodiment, wind module includes features that allow the user to reliably set a pivot clearance for the wind impeller shaft. In one embodiment, end play of the wind impeller shaft is critical to balance accuracy, reliability, and longevity. A method for setting this end play has been developed to reliably assemble by using adjustable inserts to change clearance. In one embodiment, this is accomplished by camming surfaces between the support and center bearing that converts a given angular change to a repeatable linear motion. Once the clearance is adjusted to zero by putting the impeller in motion and adjusting until hesitation is observed. From there a specified offset is applied and adhesive applied to fix the position. In another instance, setting desired end play may be accomplished by using an insert of varying thickness, using a threaded interface, or using an adjusting screw to set clearance by moving the support.

In addition to a wind module, other modules could include but are not limited to: an environmental module, a module that contains a wind speed sensor in addition to atmospheric sensors, a wind speed sensor that may measure wind via a rotating impeller, ultrasonic sensors, measuring strain of an element, heat loss of a wire, or other method. In one embodiment, the other modules may be an integrated part of the ballistic weather meter or as independent remote sensor(s) that wirelessly communicate to the meter.

In one embodiment, external modules may be connected mechanically and electronically to the ballistic weather meter, wherein the external module is in communication with the meter. In one embodiment, external modules may include a separate integrated power source consisting of one or more of a main battery source, secondary solar source and kinetic source. In addition, the ballistic weather meter may include a connection point that enables the wind module to be mounted on a pole, tripod, or other base when utilized as a stand-alone device communicating wirelessly with the meter.

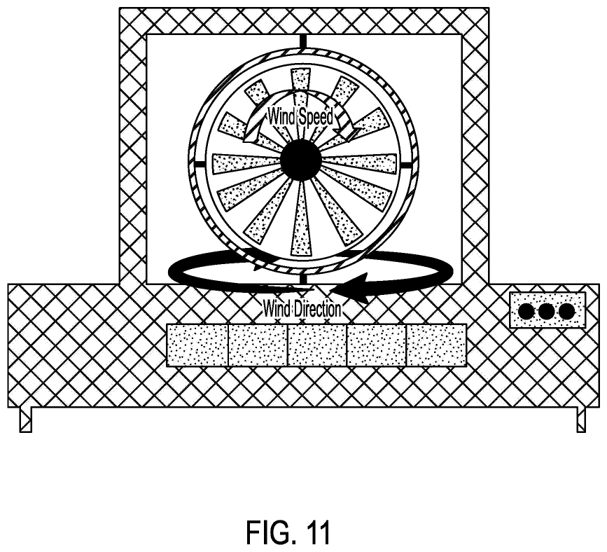

As described above and as shown in FIGS. 8-9, the ballistic weather meter can be connected to and communicate with multiple external modules simultaneously. For example, the external modules may be affixed to mountings pole that allow the user to place the wind module at various spacing to accurately capture wind and atmospheric data over a specified range. For example, modules can be placed at 0, 50, 250, 500, 700, and 1200 yards to create a wind profile. The wind modules may wirelessly communicate wind speed, wind direction, temperature, pressure, and humidity to the ballistic weather meter. The array of wind and atmospheric data is utilized to input into the ballistic calculator to calculate a more accurate wind & elevation ballistic correction. FIG. 11 is a schematic view of one embodiment of a rotatable wind impeller housing in accordance with the non-limiting principles of this disclosure.

In one embodiment, the ballistic weather meter may collect wind and atmospheric data from each module to create a real-time map of wind and atmospherics over the specified range. The ballistic weather meter utilizes data from the modules to create wind speed & direction maps, pressure maps, temperature maps, humidity maps. Maps can be generated and display both as 2D and 3D (topographical) images without departing from the principles of this disclosure. In one embodiment, a combination map also can display wind and atmospheric over a topographical map.

Another embodiment of an external module within the principles of this disclosure is an emergency beacon module. In one embodiment, the emergency beacon module may provide 2-way emergency satellite communication. Such a module may contain an “SOS” button that sends emergency responders your GPS location when pressed. In one embodiment, the emergency beacon module may enable SMS (Short Message Service) communication with emergency services. This may allow the user to send and receive text messages when out of range of cellular services. Emergency beacon module may be an integrated part of the ballistic weather meter or an independent remote communication device that wirelessly communicates to the meter. Emergency beacon module may include a separate integrated power source consisting of a main battery source, secondary solar source, and/or kinetic source without departing from the principles of this disclosure.

Another embodiment of an external module within the principles of this disclosure is a solar power module that provides an additional power source to the ballistic weather meter. In one embodiment, the solar power module has integrated solar panels that converts solar light into electrical energy. The converted energy may be utilized to provide a source of power for the ballistic weather meter. In one embodiment, the solar power module can be utilized to power the ballistic weather meter or to recharge the meter's rechargeable battery.

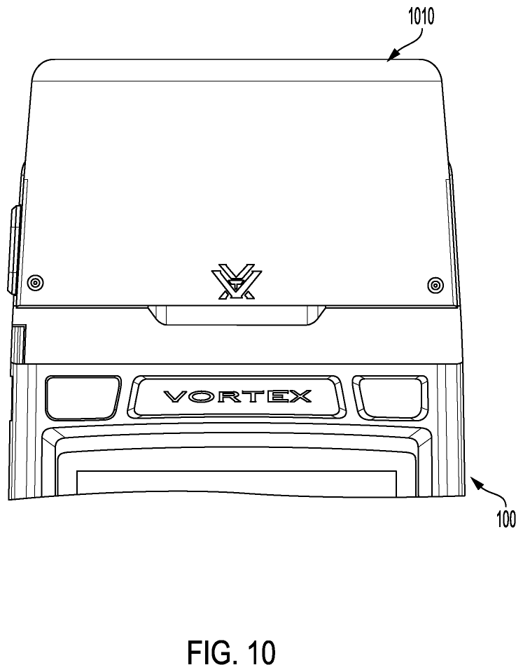

Another embodiment of an external module within the principles of this disclosure is a battery module (1010) that provides an additional power source to the ballistic weather meter (100). FIG. 10 is a schematic view of one embodiment of a battery module in accordance with the non-limiting principles of this disclosure.

In one embodiment, the battery module includes an integrated rechargeable battery pack. The battery module can be recharged utilizing the solar module, by another mobile device (via USBC, for example), or any other suitable power source. The battery power module may be utilized to power the ballistic weather meter or to recharge the meter's rechargeable battery.

Another embodiment of an external module within the principles of this disclosure is a wind module that provides a lower cost option and only measures wind conditions. One embodiment of a wind speed and direction module may measure wind conditions, including wind direction via a rotationally unconstrained wind vane.

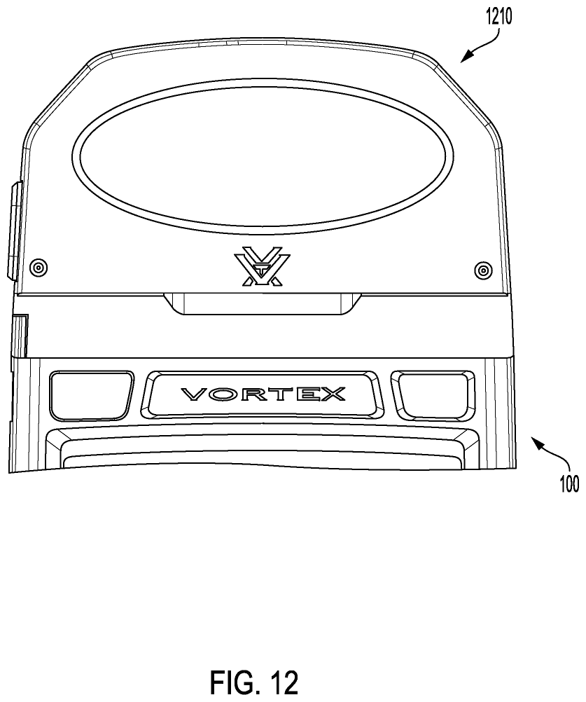

Another embodiment of an external module within the principles of this disclosure is a motion sensor module (1210). FIG. 12 is a schematic view of one embodiment of a motion sensing module (1210) in accordance with the non-limiting principles of this disclosure.

In one embodiment, a motion sensor module can be placed in strategic locations to send alerts when motion is detected in specific locations. This can give a hunter early notification of an animal approaching.

Yet another embodiment of an external module within the principles of this disclosure is a weapon data module. The weapon data module may be mounted to a weapon to record specific weapon conditions including but not limited to: number of rounds fired, barrel temperature, weapon orientation information, weapon identification information, rounds remaining in magazine, external applied forces that would result in inaccuracies, and muzzle velocity.

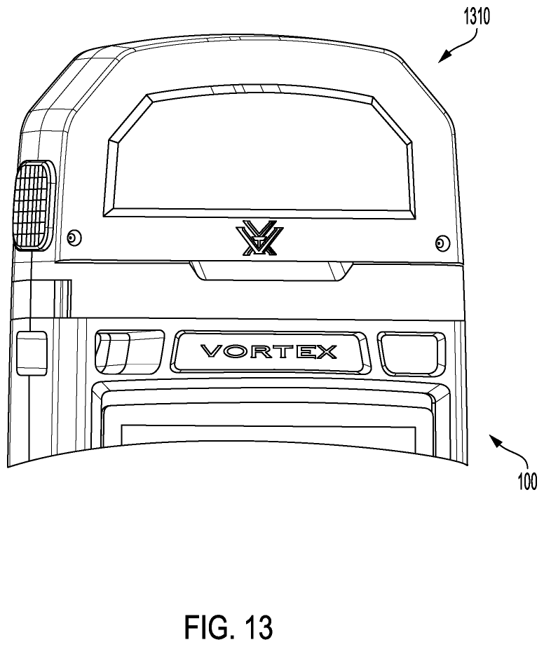

Another embodiment of an external module within the principles of this disclosure is a chronograph module (1310) that includes sensors used to determine the speed of a bullet. FIG. 13 is a schematic view of one embodiment of a chronograph module in accordance with the non-limiting principles of this disclosure.

This information can be fed back into the weapon profile the user has selected. Of course, other modules may include more or fewer features without departing from the principles of this disclosure.

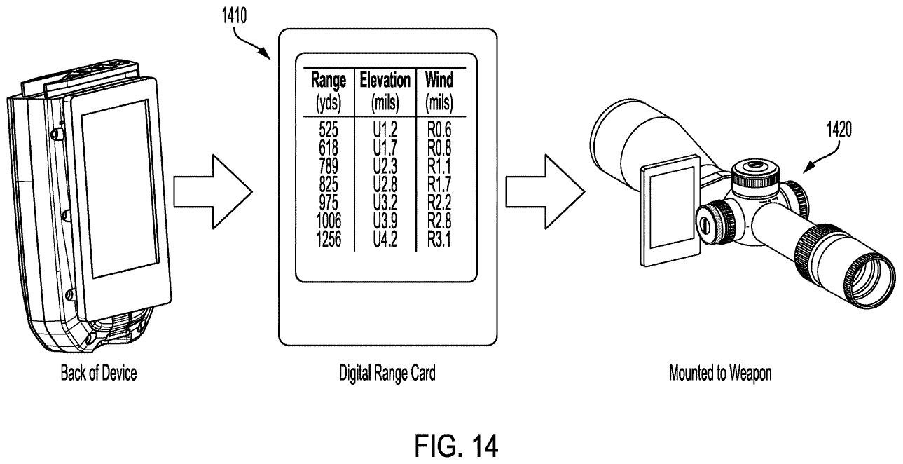

A card including target name, target distance, elevation correction and windage correction is commonly referred to as a dope card. As shown in FIG. 14, the ballistic weather meter may include an updateable, e-paper display (1410) that is populated with information commonly on a dope card. Of course, other display technologies may be used without departing from the principles of this disclosure. The display may be updated using wired or wireless data communication. Though there are other similar products like the E-Dope card sold by Down Range Systems, for example, the display disclosed herein is unique because it can update the display directly, rather than by an external app installed on a smartphone or similar device. In addition, in one embodiment, the ballistic weather meter includes mechanical features that align an NFC receiver (attached to the display), with an NFC transmitter (attached to the ballistic weather meter). This prevents failed attempts to update the e-paper display, which is a common problem in existing technology.

The dope card provides the shooter with a way to easily read the ballistic solutions while they are shooting. The dope card is easily mounted to a rifle (1420) or to the body of the shooter such that it can be referenced quickly and is unintrusive to the mechanics of actually shooting. In addition, in one embodiment, the removable dope card may not require batteries to continue to display the information. It is challenging to mount the ballistic weather to a weapon, carry while shooting, and has the potential of the ballistic weather meter batteries dying.

In one embodiment, the dope card can be mounted to the back portion (200) of the ballistic weather meter (100) via a mount or case, or features integrated into the meter. The dope card can be removed so it can be mounted on a rifle mounted range card holder, wrist band, or forearm band so the user has accessible range card dope data.

In one embodiment, the ballistic weather meter includes mechanical features that optimize communication between the meter and the removable dope card. The ballistic weather meter may also include mechanical features that provide a safe storage compartment for the removable dope card.

In one embodiment, the dope card may have one or more of the following characteristics:
Dope Data/Range Cards can be wirelessly transmitted from the handheld base.
The Digital Dope Card is flexible and durable plastic card that can be mounted in various configurations such as:
   Affixed to the back of the handheld base.
   Affixed to a rife via a dope card holder.
   Affixed to a rifle via hook and loop tape, or similar method.
   Affixed to a wrist band.
   Affixed to an arm band.
The Digital Dope card can also receive dope/range card data from wirelessly from other Vortex Network devices with range card capabilities.
The Digital Dope Card that is the approximate size of a standard business card (2″×3.5″).
The Digital Dope Card can be stored in a recessed area on the back of the handheld base.
Once the Dope/Range Card data is transmitted to the Digital Dope card, the data is retained without the need for external power, connection, or communication. The Dope/Range card display data is maintained until overwritten.
The Digital Dope Card is a consumable. Damaged or lost Digital Range Cards can easily and cheaply be replaced.

In one embodiment, the dope card can be mounted in a powered arm/wrist band. The wrist band allows the dope/range card data to be updated wirelessly via the ballistic weather meter or any Vortex Network device with dope/range card capabilities.

It is specifically intended that the disclosure is not limited to the embodiments and illustrations contained herein, but include modified forms of those embodiments including portions of the embodiments and combinations of elements of different embodiments as come within the scope of the following claims.

What is claimed is:

1. A device comprising: a body having a front portion, a back portion, a top portion, and a bottom portion, the front portion having a multi-button interface and a display, the body having an inner portion with a processor with at least one ballistic calculator, a system for wireless communications, the top portion having a mounting feature for a removable first module, and a removable first module configured to mount to the top side of the device.

2. The device of claim 1, wherein the multi-button interface is a five button interface.

3. The device of claim 1, where the at least one ballistic calculator is one ballistic calculator.

4. The device of claim 1, wherein the back portion is configured to secure a range card.

5. The device of claim 1, wherein the at least one ballistic calculator is two ballistic calculators.

6. The device of claim 1, wherein the at least one ballistic calculator is from one to ten ballistic calculators.

7. The device of claim 1, wherein the mounting feature comprises a rail interface, a connector, and a latch button.

8. The device of claim 1, wherein the system for wireless communications is Bluetooth communication.

9. The device of claim 1, wherein the removable first module is selected from the group consisting of: an environmental and weather related module, a wind measurement module, a Global Positioning System (GPS) beacon, a flashlight, a solar panel configured to provide power to the device, a battery pack configured to provide power to the device, a shot timer, and a mosquito repellent system.

10. The device of claim 1, wherein the removable first module is an environmental and weather related module.

11. The device of claim 1, wherein the removable first module has a mounting feature for a removable second module.

12. The device of claim 11, further comprising a removable second module, wherein the removable second module is configured to mount to the first module and has a mounting feature for a removable third module.

13. The device of claim 12, wherein the removable first module is a battery pack configured to provide power to the device and the removable second module is an environmental and weather related module.

14. The device of claim 1, wherein the removable first module is a battery pack configured to provide power to the device.

15. The device of claim 1, wherein the removable first module is a solar panel configured to provide power to the device.

16. The device of claim 1, wherein the device communicates with a rangefinder or a riflescope, or a binocular, or a spotting scope, or a thermal devices, or a night vision device, or a ballistic fob, or a heads-up display, or a mobile phone.
